(19) United States
(12) Patent Application Publication
(10) Pub. No.: US 2015/0012405 A1
(43) Pub. Date: Jan. 8, 2015

(54) Market Data Display Including Order Availability Indicators

(71) Applicant: Trading Technologies International, Inc., Chicago, IL (US)

(72) Inventor: Brian J. Buck, Livermore, CA (US)

(73) Assignee: Trading Technologies International, Inc., Chicago, IL (US)

(21) Appl. No.: 13/935,121

(22) Filed: Jul. 3, 2013

(51) Int. Cl. G06Q 40/04

(52) U.S. Cl. CPC G06Q 40/04
USPC 705/37

(57) ABSTRACT

Some embodiments of the invention provide systems and methods for displaying market data which are operatively configured to present the minimum remaining time available for a trade order to be placed for a tradable object at any given price by converting numerical values to graphical or visual representations thereof for reducing the amount of cognitive workload required to review, detect, and monitor the market data, among other things, while also continuing to convey useful information that facilitates the execution of trades in tradable objects.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders. The trading device may be any computing device, such as such as a personal computer, laptop computer, hand-held computer, tablet computer, smart phone or some other device that includes a display, user interface and includes hardware for communication with the electronic exchange. Traders link to the electronic exchange through one or more networks to trade, that is, buy and sell, tradable objects.

Traders often use automated or semi-automated trading tools, collectively hereinafter referred to as automated tools that automatically or semi-automatically send orders for tradable objects to the exchange. Many different trading tools are usually provided to, among other things, facilitate fast and accurate order entry. For instance, an automated or semi-automated tool might quickly calculate one or more order parameters, such as order price or order quantity, based on market conditions, or some other reference condition, and then automatically send an order with these parameters to an exchange for matching.

Traders frequently execute trading strategies that require the tracking of a large amount of individual tradable objects and the need to assimilate large amounts of data in order to recognize market trends, view current market conditions, and quickly enter, cancel, update, and modify orders. Thus, traders employ specialized trading interfaces for assistance. Typical trading interfaces present a variety of information, which may include the status of each tradable object in a line of numeric data fields covering key variables relevant to trading, such as price, quantity available at each price, the level of inside market, and others. Traders may regularly operate many such trading interfaces in order to track market conditions for a plurality of tradable objects and execute various trading strategies simultaneously. The use of multiple interfaces with various numerical values can become burdensome to a trader who needs to accurately view and consider critical changes in the market conditions of a large number of tradable objects. These interfaces require high levels of visual scanning of which make it difficult to detect and analyze changes in market conditions on a real time basis as necessary to properly execute trading strategies. In short, the interfaces that are supposed to help the trader operate more efficiently and effectively can ultimately become overwhelming to the detriment of the trader.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an exemplary trading interface format for presenting market data and minimum order availability time information relating to a tradable object which may be employed with certain disclosed embodiments.

FIG. 5 illustrates another exemplary trading interface format for presenting market data and minimum order availability time information relating to a tradable object relating to a tradable object which may be employed with certain disclosed embodiments.

FIG. 6 is a flow diagram illustrating an exemplary method for presenting market data and minimum order availability time information, among other things, relating to a tradable object which may be employed with certain disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments are generally related to systems and methods for providing trading interfaces that include trading tools and display market data in a manner which assists traders in quickly reviewing and processing information for the purpose of executing trades. Some embodiments are directed to systems and methods for displaying market data which are operatively configured to provide graphical or visual representations of timing information, such as the period of time remaining that a tradable object will remain available to be bought or sold at a particular price, which reduces the amount of cognitive workload required to review, detect, process and monitor the market data, among other things, while also continuing to convey useful information that facilitates the execution of trades in tradable objects.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

### I. Brief Description of Certain Embodiments

Some embodiments disclosed herein are directed to a method for displaying market data which is facilitated by a computing device in communication with an electronic exchange and comprises the steps of displaying an interface format for presenting current market data in an area of a display device.

The interface format may include a plurality of generally axially aligned price regions defining a central price axis, wherein each of the axially aligned price regions contain therein a price for a tradable object in sequential order along the price axis; a plurality of ask regions, wherein each ask region of the plurality of ask regions is transversely aligned to a price region relative to the central price axis and contains a numerical value representing a current quantity of ask orders at the price displayed in the transversely aligned price region, thereby displaying a positional relationship between the current quantity of ask orders and a price along the central price axis for at least indicating the price of each ask order of the current quantity of ask orders; and a plurality of bid regions, wherein each bid region of the plurality of bid regions is transversely aligned to a price region relative to the central price axis and contains a numerical value representing a current quantity of bid orders at the price displayed in the transversely aligned price region, thereby displaying a positional relationship between the current quantity of bid orders and a price along the central price axis for at least indicating the price of each bid order of the current quantity of bid orders.

The aforementioned method is configured for determining an order availability time for at least one of the ask orders or at least one of the bid orders. The order availability time may correspond to the period of time during which the at least one of the ask orders or the at least one of the bid orders will remain available for execution at its respective indicated price.

The aforementioned method is also configured for displaying a visual representation of the order availability time determined for the at least one of the ask orders or the at least one of the bid orders. The visual representation of the order availability time determined may be positioned in a transversely aligned position from the respective indicated price relative to the central price axis.

In some embodiments, the visual representation is a transversely extending shape, wherein the size or transverse extent of the shape is scaled to correspond with the quantity of ask orders or respective quantity of bid orders associated with the order availability time determined at the indicated price.

In some embodiments, the order availability time for all ask orders and all bid orders is determined and displayed as visual representations of the quantity of ask orders or the quantity of bid orders for each price which have their respective order availability time in common.

In some embodiments, the disclosed method is further configured for comparing the order availability time determined for the ask orders or the bid orders with one or more preset time periods; identifying the preset time period which corresponds to the order availability time determined for the ask orders or the bid orders; and displaying one or more time period indicators as part of the visual representation of order availability times, wherein each of the one or more time period indicators represent the amount of ask orders or the amount of bid orders in an identified time period. In some embodiments, the time period indicators are colors.

Some embodiments are directed to a system for displaying market data which includes a computing device in a communication with an electronic exchange; a display device for displaying an interface format of current market data in a first area of the display device, wherein the first interface format may include all of the features described above and/or the features of the exemplary embodiments described herein below, and the computing device determines the order availability and displays visual representations as described above and/or by the features of the exemplary embodiments described herein.

Other embodiments are directed to a non-transitory computer-readable information recording medium which stores a program for controlling a computer to receive market data from an electronic exchange, the program comprising code for permitting the computer to perform the steps described herein including all of the features described above and/or the features of the exemplary embodiments described herein below.

### II. Example Electronic Trading System

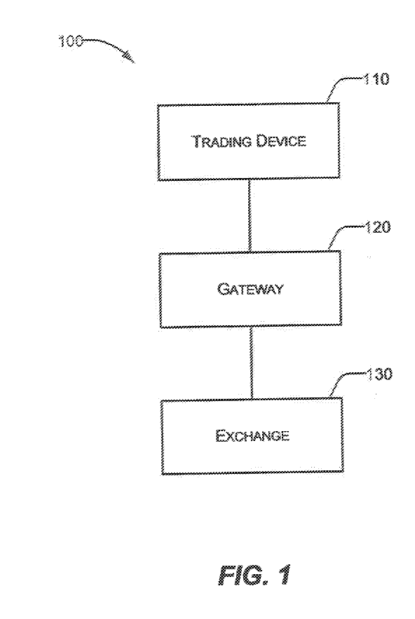

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradable objects to the exchange 130. As used herein, the term “tradable object” refers to anything that can be traded with a quantity and/or price. It includes, but is not limited to, all types of traded events, goods and/or financial products, which can include, for example, stocks, options, bonds, futures, currency, and warrants, as well as funds, derivatives and collections of the foregoing, and all types of commodities, such as grains, energy, and metals. The tradable object may be “real,” such as products that are listed by an exchange for trading, or “synthetic,” such as a combination of real products that is created by the user. A tradable object could actually be a combination of other tradable objects, such as a class of tradable objects.

Market data may include data about a market for a tradable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradable object is anything which may be traded. For example, a certain quantity of the tradable object may be bought or sold for a particular price. A tradable object may include, for example, financial products, stocks, options, bonds, future contracts, currency, warrants, funds derivatives, securities, commodities, swaps, interest rate products, index-based products, traded events, goods, or a combination thereof. A tradable object may include a product listed and/or administered by an exchange (for example, the exchange 130), a product defined by the user, a combination of real or synthetic products, or a combination thereof. There may be a synthetic tradable object that corresponds and/or is similar to a real tradable object.

An order message is a message that includes a trade order. A trade order may be, for example, a command to place an order to buy or sell a tradable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradable objects, for example, offered for trading by the exchange, to be bought and sold. The exchange 130 may include separate entities, some of which list and/or administer tradable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

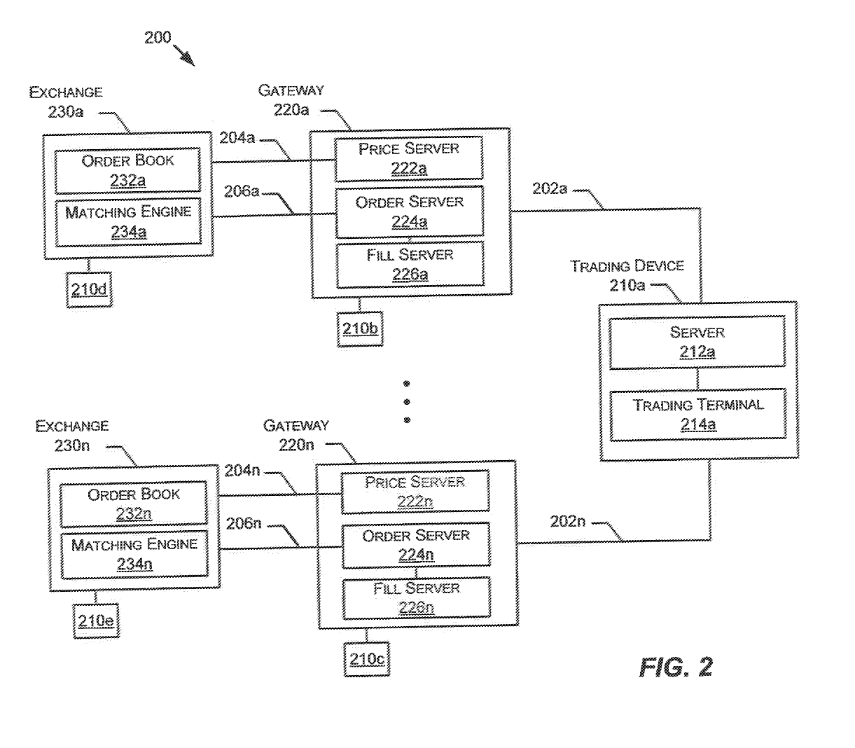

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. Example Computing Device

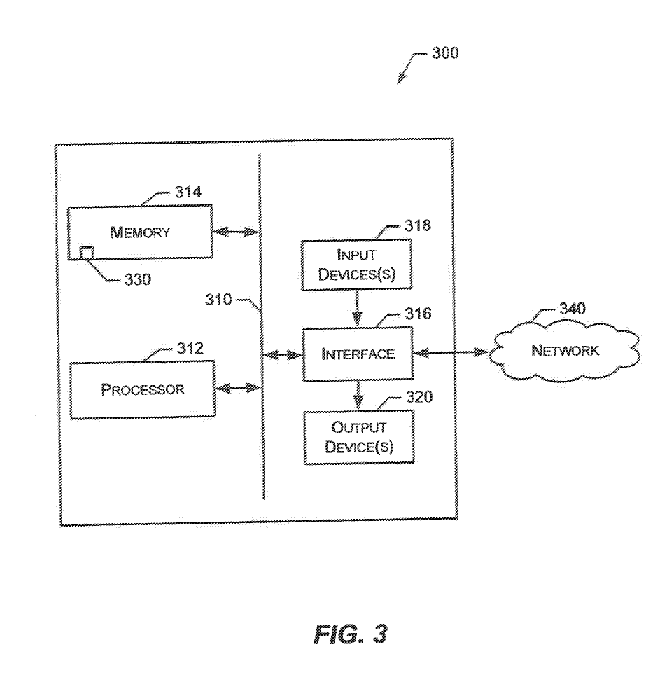

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Market Data Display with Integrated Order Availability Indicators

Exemplary embodiments described below include various trading interfaces that present market data in a format which is intended to allow a trader to gain a fast, accurate, and comprehensive view of the current market conditions for a large number of tradable objects through data visualization, among other things. As used herein, the term market data is not intended to be limited to any particular type of data, and may include information received directly from the exchange 130 or data generated by the trading device 300 (as a function of the market data received from the exchange 130 or otherwise), for example.

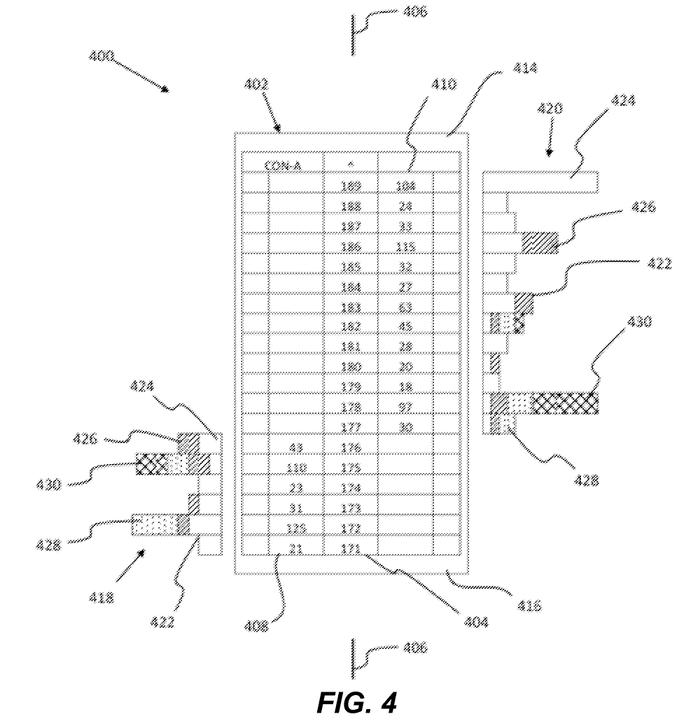

FIG. 4 provides an embodiment of an exemplary trading interface of the invention referred to herein as a trading interface format 402 for presenting market data relating to a tradable object. Interface format 402 may be displayed in a display area 400 defined on any type of display device in communication with computing device 300, and may be connected with or otherwise comprise output device 320.

In this embodiment, trading interface format 402 includes a plurality of price regions 404 arranged in axial alignment with one another defining a central axis 406. Interface format 402 further includes a plurality of bid quantity regions 408 and a plurality of ask quantity regions 410. The plurality of bid quantity regions 408 are axially aligned with one another defining a bid quantity column 412 having an axis which is parallel to central axis 406. The plurality of bid quantity regions 408 are located in a generally a transverse position with respect to central axis 406 defined by the plurality of price regions 404. The plurality of ask quantity regions 410 are axially aligned with one another defining an ask quantity column having an axis which is parallel to central axis 406. The plurality of ask quantity regions 410 are therefore located in a generally a transverse position with respect to central axis 406 defined by the plurality of price regions 404, similarly to the plurality of bid quantity regions 408 but on the opposing side of central axis 406 in this embodiment.

Each price region 404 in trading interface format 402 contains a numerical value representing a price for the tradable object. Either the bid quantity region 408 or the ask quantity region 410 transversely adjacent to each price region 404 relative to central axis 406 may contain a numerical value. The numerical value in each bid quantity region 408 and each ask quantity region 410 represents either the current total quantity of bid orders (also referred to as the “bid quantity”) or the current total quantity of ask orders (the “ask quantity”) for the tradable object at the price indicated in the respective price region 404 transversely adjacent thereto. In this embodiment, the numerical price values shown in price regions 404 are presented in sequential order from lowest price at a bottom 416 of interface format 402 to highest price at a top 414 of interface format 402.

Timing data relating to the tradable object, such as the amount of time generally or from present that the orders may or must be available for execution may be received with the market data, through a price feed or otherwise obtained through another data connection with electronic exchange 130. In some embodiments, the timing data may be determined from other information, such information relating to market data or each order. For example, the timing data, including the order availability time, may be determined from information regarding the type of order. This may include information such as whether the order is a limit order, market order, stop loss order, day order or otherwise, and may also include information such as the time the order was entered, particularly for orders that must remain available for execution for at least a preset period of time after being entered. In other embodiments, the timing data may be an indication of how long an order has been active in the market. For example, the aging information could provide useful information about the level of activity within a market.

In this embodiment, the timing data is used to determine the order availability time each bid order and each ask order forming the bid and ask quantities must be available for execution at the price indicated in the respective price region 404 transversely adjacent thereto. Computing device 300 converts or otherwise displays the determined order availability time as a representative display, which may be one or more graphics, symbols, colors or anything else that readily suggests, or allows a trader to readily infer the determined order availability time.

In this embodiment, computing device 300 displays the determined “guaranteed” minimum order availability times through timing visualization bars 418 for bid orders and timing visualization bars 420 at positions in display area 400 which are transversely adjacent to the price indicated in price region 404 and on opposing sides of central axis 406. Bid timing bars 418 extend transversely with respect to central axis 406 as shown in interface format 402. Ask timing bars 420 also extend transversely with respect to central axis 406, but in the opposing direction of bars 418.

In this embodiment, the transverse length of each bar 418 is formed for display in trading interface 402 by considering the bid quantity numerical value contained in the corresponding bid quantity region 408 relative to the other bid quantity numerical values in the other bid quantity regions 408. In other words, each bar 418 has a scaled or normalized transverse length relative to the other bars 418 and presents a visual representation of the bid quantity magnitude associated with the transversely adjacent price for the trading object. Likewise, each bar 420 was formed for display in trading interface 402 by considering the ask quantity numerical value contained in the corresponding ask quantity region 410 relative to the other ask quantity numerical values in the other ask quantity regions 410. Each bar 420 also has a scaled or normalized transverse length relative to the other bars 420 and presents a visual representation of the ask quantity magnitude associated with the transversely adjacent price for the trading object.

Thus, all of the numerical values in bid regions 408 and ask regions 410 shown in trading interface 402 have been converted into representative visualizations for display as bars 418 and 420 that reveal a relative amount of bid quantities or ask quantities relative to a particular price. For example, the lengthier bars 418 will be transversely adjacent to higher bid quantity values shown in bid regions 408.

In this embodiment, each bar 418 and 420 is divided into or composed of a plurality of segments 422 that include distinguishable indicators of order availability time. Segments 422 are scaled so that each individual segment and respective indictor represents a portion or amount of the bid or ask orders among the total current bid or ask quantities which have about, substantially the same or the same, order availability times. In this embodiment, the distinguishable indicator of order availability time displayed in segments 422 is a color, but other distinguishing features may be employed, such as patterns, alphanumeric characters or other graphics for example.

In this embodiment, segments 422 include a first color indicator 424 indicating that the required order availability time is associated with a first period of time, a second color indicator 426 which indicates that the required order availability time is associated with a second period of time, a third color indicator 428 which indicates that the required order availability time is associated with a third period of time, and a fourth color indicator 430 which indicates that the required order availability time is associated with a fourth period of time. It should be understood that either more or less time periods may be indicated in accordance with this invention.

The timing data and order availability time may be determined, and then compared with threshold timing criteria for assigning a color for display as segments 422. For example, the first period of time may be zero in that segment 424 represents the orders at the indicated price that have no required order availability time and may therefore be withdrawn from the market at any time, the second period of time may be two seconds so that segment 426 represents the orders at the indicated price which are associated with a required or minimum order availability time of at least two seconds, the third period of time may be four seconds so that segment 428 represents the orders at the indicated price which are associated with a minimum order availability time of at least four seconds, and the fourth period of time may be six seconds so that segment 430 represents the orders at the indicated price which are associated with a minimum order availability time of at least six seconds.

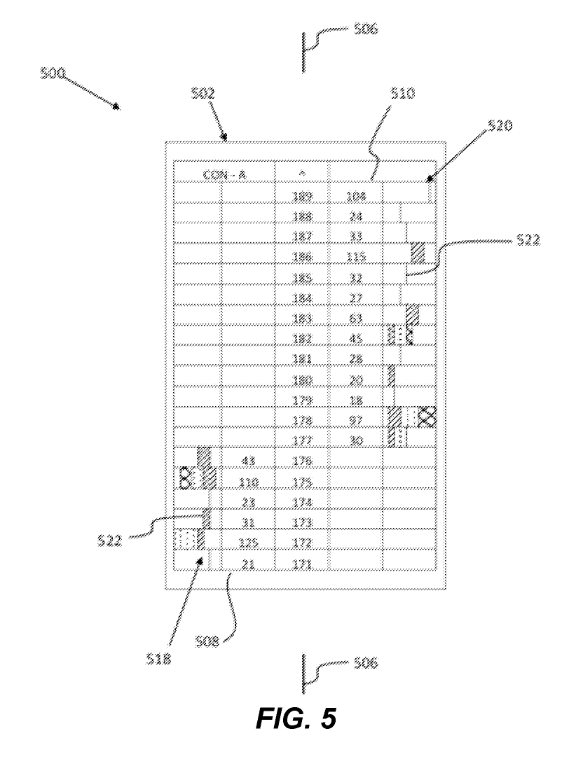

FIG. 5 illustrates a trading interface 502 in which bars 518 and 520 having segments 522 are displayed transversely adjacent to respective bid regions 508 and ask regions 510 respectively at a relatively closer position than as compared with trading interface 402, thus providing a narrower profile for trading interface 502. In other embodiments, the bars 518 and 520, and segments 522 may be superimposed over the quantities displayed in the respective bid regions 508 and ask regions 510.

Trading interfaces of the invention, such as interfaces 402 and 502 may incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons that may be can be selected (i.e., “clicked on” or “touched”) by the user via input device 318, which may include or comprise a connected mouse, keyboard or touch-enabled display device. Thus, a user may alternately toggle between trading interface 402 and interface 502.

The embodiments herein describe new systems, methods and interfaces that allow a trader to better visualize the status of a large number of orders corresponding to a plurality of tradable objects shown on their display screen.

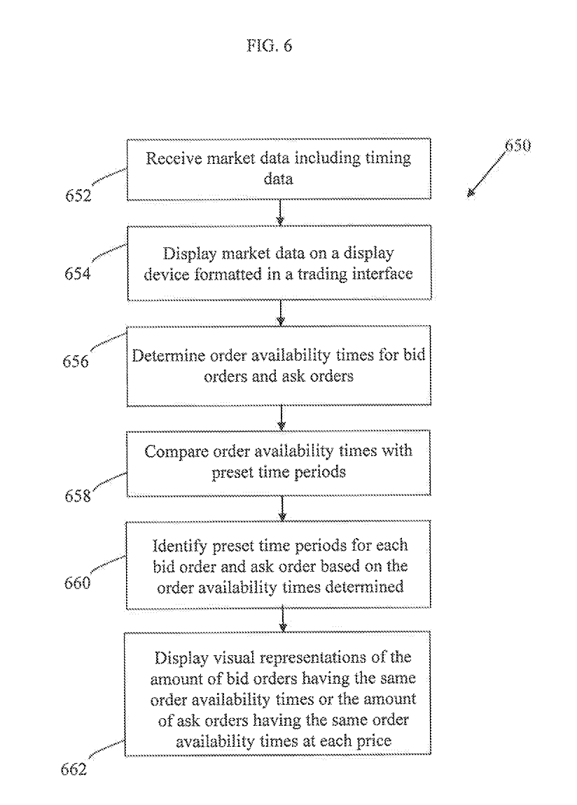

FIG. 6 provides exemplary functional steps of a method of carrying out the invention generally referred to as method 650 through a computing device such as computing device 300.

As shown by step 652, market data and timing data for a tradable object are received by, for example, computing device 300, through one or more sources. The market data is displayed in step 654 on a display device through a trading interface that formats the market data, such as trading interface 402 which includes displaying prices for the tradable object in price regions, along with bid quantities or ask quantities for the displayed prices.

In step 656, the timing data for each bid order and each ask order of each respective bid quantity or ask quantity at any price is used to determine the order availability time. In step 658, the order availability time is either compared with preset time periods, such as 0 seconds, two seconds, four seconds and six seconds or bid orders or ask orders having the same order availability times are grouped. The bid orders and ask orders having the same preset time periods are identified as groups in step 660 based on the order availability times. Each of the preset time periods are associated with a visually distinguishable indicator for display on a display device.

In step 662, graphics, such as segments 422, are displayed on the display device with the visually distinguishable indicators of each of the time periods. In some embodiments, the visually distinguishable indictor may include different colors as indicators of the respective time periods. The graphics are of a size which is scaled relative to one another to represent the current amount of bid quantities and the current amount of ask quantities at any given price. The size of the graphic displayed, along with the indicators which may be displayed along with or as part of the graphic, thus visualize the amount of bid orders and amount of ask orders which have the same order availability time at any given price. In some embodiments, segments 422 may be scalable bars displayed in a form which represents the magnitude of bid orders or ask orders in each time period relative to the total current magnitude of the bid quantity or the total current magnitude of the ask quantity for any price in the displayed price regions. In this embodiment, the graphics are sized and include indicators or time that enable them to provide visualizations of the relative amounts of bid orders or ask orders at each price and their order availability times.

The combination of segments 422 at each price form either a bar 418 and or a bar 420, and each bar 418 therefore represents either the total current magnitude of the bid quantity while each bar 420 therefore represents the total current magnitude of the ask quantity for any price in the displayed price regions, as compared with the current bid quantities or current ask quantities at other prices.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

1. A method for displaying market data by a computing device in a communication with an electronic exchange, the method comprising the steps of:
displaying via a display device of the computing device an interface format for presenting current market data received from the electronic exchange in an area of the display device including:
a plurality of generally axially aligned price regions defining a central price axis, wherein each of the axially aligned price regions include therein a price for a tradable object, and wherein the axially aligned price regions are aligned in sequential order along the central price axis;
a plurality of ask regions, wherein each ask region of the plurality of ask regions is transversely aligned relative to the central price axis and includes a numerical value representing a current quantity of ask orders available for trading, thereby displaying a positional relationship between the current quantity of ask orders and the central price axis for at least indicating a price of each ask order of the current quantity of ask orders;
a plurality of bid regions, wherein each bid region of the plurality of bid regions is transversely aligned relative to the central price axis and includes a numerical value representing a current quantity of bid orders available for trading, thereby displaying a positional relationship between the current quantity of bid orders and the central price axis for at least indicating a price of each bid order of the current quantity of bid orders;
receiving, via a processor of the computing device from the electronic exchange, timing data related to the ask orders and the bid orders;
determining via the processor of the computing device an order availability time for at least one of the ask orders or at least one of the bid orders, wherein the order availability time is determined based on the received timing data and corresponds to a period of time during which the at least one of the ask orders or the at least one of the bid orders will remain available for execution at its respective indicated price; and
displaying via the display device of the computing device a visual representation of the order availability time determined for the at least one of the ask orders or the at least one of the bid orders, wherein the visual representation is displayed in a transversely aligned position from the respective indicated price relative to the central price axis.

2. The method according to claim 1, wherein the step of displaying a visual representation of the order availability time determined for the at least one of the ask orders or the at least one of the bid orders further comprises displaying a transversely extending shape, wherein the transverse extent of the shape is scaled to correspond with the total amount of ask orders or total amount of bid orders having the same order availability time determined at the indicated price.

3. The method according to claim 1, further comprising the step of displaying a visual representation corresponding to the magnitude of either the quantity of ask orders or the quantity of bid orders for a price at a transversely aligned position from the respective price, wherein the visual representation comprises a transversely extending shape, wherein the extent of the shape is scaled to correspond with the total quantity of ask orders or the total quantity of bid orders corresponding to each price.

4. The method according to claim 1, wherein the step of determining an order availability time for at least one of the ask orders or at least one of the bid orders further comprises determining an order availability time for all of the ask orders or all of the bid orders.

5. The method according to claim 4, wherein visual representations are displayed for the ask orders and the bid orders and are transversely aligned to opposing sides of the central price axis.

6. The method according to claim 1, further comprising the steps of: comparing the order availability time determined for the at least one of the ask orders or the at least one of the bid orders with one or more preset time periods; identifying the preset time period corresponding to the order availability time determined for the at least one of the ask orders or the at least one of the bid orders; and displaying one or more time period indicators as part of the visual representation, wherein each of the one or more time period indicators represent the amount of ask orders or the amount of bid orders in an identified time period.

7. The method according to claim 6, wherein the time period indicators comprise one or more colors.

8. The method according to claim 1, wherein the order availability time comprises an amount of time during which a bid order or ask order must be available for execution at an identified price.

9. A system for displaying market data comprising:
a computing device in a communication with an electronic exchange for receiving market data from the electronic exchange;
a display device for displaying an interface format of current market data in an area of the display device, wherein the first interface format includes:
a plurality of generally axially aligned price regions defining a central price axis, wherein each of the axially aligned price regions include therein a price for a tradable object, and wherein the axially aligned price regions are aligned in sequential order along the central price axis;
a plurality of ask regions, wherein each ask region of the plurality of ask regions is transversely aligned relative to the central price axis and includes a numerical value representing a current quantity of ask orders available for trading, thereby displaying a positional relationship between the current quantity of ask orders and the central price axis for at least indicating a price of each ask order of the current quantity of ask orders;
a plurality of bid regions, wherein each bid region of the plurality of bid regions is transversely aligned to a price region relative to the central price axis and includes a numerical value representing a current quantity of bid orders available for trading, thereby displaying a positional relationship between the current quantity of bid orders and the central price axis for at least indicating a price of each bid order of the current quantity of bid orders;
the computing device receiving timing data related to the ask orders and the bid orders from the electronic exchange and being configured for determining an order availability time for at least one of the ask orders or at least one of the bid orders, wherein the order availability time is determined based on the received timing data and corresponds to a period of time during which the at least one of the ask orders or the at least one of the bid orders will remain available for execution at its respective indicated price; and
displaying a visual representation of the order availability time determined for the at least one of the ask orders or the at least one of the bid orders in a transversely aligned position from the respective indicated price relative to the central price axis.

10. The system of claim 9, wherein the display device and computing device are mounted in a unitary housing.

11. The system of claim 9, wherein the user display device and user input device are mounted in a unitary housing.

12. A non-transitory computer-readable information recording medium which stores a program for controlling a computer to receive market data from an electronic exchange, the program comprising code for permitting the computer to perform the following steps:
displaying via a display device of a trading device an interface format for presenting current market data received from an electronic exchange in an area of the display device including:
a plurality of generally axially aligned price regions defining a central price axis, wherein each of the axially aligned price regions include therein a price for a tradable object, and wherein the axially aligned price regions are aligned in sequential order along the central price axis;
a plurality of ask regions, wherein each ask region of the plurality of ask regions is transversely aligned to a price region relative to the central price axis and includes a numerical value representing a current quantity of ask orders available for trading, thereby displaying a positional relationship between the current quantity of ask orders and the central price axis for at least indicating a price of each ask order of the current quantity of ask orders;
a plurality of bid regions, wherein each bid region of the plurality of bid regions is transversely aligned to a price region relative to the central price axis and includes a numerical value representing a current quantity of bid orders available for trading, thereby displaying a positional relationship between the current quantity of bid orders and the central price axis for at least indicating a price of each bid order of the current quantity of bid orders;
receiving, via a processor of the trading device from the electronic exchange, timing data related to the ask orders and the bid orders;
determining via the processor of the trading device an order availability time for at least one of the ask orders or at least one of the bid orders, wherein the order availability time is determined based on the received timing data and corresponds to a period of time during which the at least one of the ask orders or the at least one of the bid orders will remain available for execution at its respective indicated price; and
displaying via the display device of the trading device a visual representation of the order availability time determined for the at least one of the ask orders or the at least one of the bid orders in a transversely aligned position from the respective indicated price relative to the central price axis.
